(19) United States
(12) Patent Application Publication
(10) Pub. No.: US 2004/0086028 A1
(43) Pub. Date: May 6, 2004

(54) DSSS and CCK baseband decoding device and method

(75) Inventors: Wolfram Kluge, Dresden (DE); Jorg Borowski, Dresden (DE)

Correspondence Address: MEYERTONS, HOOD, KIVLIN, KOWERT & GOETZEL, P.C., P.O. BOX 398, AUSTIN, TX, 78767-0398, US

(73) Assignee: Advanced Micro Devices, Inc.

(21) Appl. No.: 10/652,092

(22) Filed: Aug. 29, 2003

(30) Foreign Application Priority Data
Oct. 31, 2002 (DE) 102 50 939.5

(51) Int. Cl. H04B 1/707

(52) U.S. Cl. 375/146

(57) ABSTRACT

Direct sequence spread spectrum encoder and method for digital information in wireless LANs are provided. The encoder comprises a spreading means for mapping two input data bits to one sequence out of four selectable, nearly orthogonal sequences being selected from 2¹⁶ possible sequences. The encoder further comprises a digital-to-analog converter connected to an output of the spreading means for generating an analog signal based on the symbols as outputted by the spreading means and a low-pass filter connected to an output of the digital-to-analog converter for low-pass filtering the analog signal.

### FIELD OF THE PRESENT INVENTION

The present invention relates to the field of baseband encoding for WLAN (Wireless Local Area Network) transmitters and in particular to transmitters complying to the IEEE 802.11 standard for 2.4 GHz WLANs.

### DESCRIPTION OF THE PRIOR ART

A wireless local area network is a flexible data communications system implemented as an extension to or as an alternative for, a wired LAN (Local Area Network). Using radio frequency or infrared technology, wireless LANs transmit and receive data over the air, minimizing the need for wired connections. Thus, wireless LANs combine data connectivity with user mobility.

Most WLAN systems use spread spectrum technology, a wide-band radio frequency technique developed for use in reliable and secure communication systems. The spread spectrum technology is designed to trade-off bandwidth efficiency for reliability, integrity and security. Two types of spread spectrum radio systems are frequently used: frequency hopping and direct sequence systems.

The standard defining and governing wireless local area networks that operate in the 2.4 GHz spectrum, is the IEEE 802.11 standard. To allow higher data rate transmissions, the standard was extended to the 802.11b standard that allows data rates of 5.5 and 11 Mbps in the 2.4 GHz spectrum. This extension is backwards compatible as far as it relates to direct sequence spread spectrum technology, but it adopts a new modulation technique called CCK (Complementary Code Keying) which allows the speed increase.

Intersil (registered trademark, formerly Harris Corporation) provides under its trademark “PRISM” a chip set for DSSS (Direct Sequence Spread Spectrum) wireless transceivers complying with the IEEE 802.11 standard. HFA 3861A designates the baseband processor of the PRISM chip set. In a typical application the baseband processor HFA 3861A is connected to QMODEM (Quad Modulator Demodulator) HFA 3783 which converts the received signals from the IF (intermediate frequency) to the baseband and forwards these signals to the receiving section of the HFA 3861A and converts the baseband signals received from the transmitting section of the HFA 3861A to the intermediate frequency. The QMODEM HFA 3783 may be connected to a HFA 3683A for up converting the transmitted signals from the intermediate frequency to the radio frequency and down converting the received signals from the radio frequency to the intermediate frequency (RF equivalent to 2.4 GHz).

The baseband processor HFA 3861A provides for differential binary phase shift keying (DBPSK) and differential quadrature phase shift keying (DQPSK) modulation schemes with data scrambling capability along with complimentary code keying (CCK) to provide a variety of data rates.

FIGS. 2 and 3 show a circuit diagram of the transmitting section of the HFA 3861A. The HFA 3861A comprises a preamble generator 21, a header generator 22 and an interface to a pay load data source 23. In this application the expression “data” is used for all kinds of data no matter as to whether they are received from the preamble generator 21, the header generator 22 or the pay load data source 23.

In order to form packets in compliance with the IEEE 802.11 standard multiplexer 24 is provided in order to select the correct data source at appropriate times. This is ensured by control circuit 27 which is connected to the multiplexer 24. The multiplexer 24 outputs the data serially at data rates of 1 Mbps (Megabits per second) 2 Mbps, 5.5 Mbps or 11 Mbps. The multiplexer 26 receives the data from the scrambler 25 and forwards the data serially via two lines either to a DBPSK/DQPSK encoder 28 for data rates of 1 or 2 Mbps or to the DBPSK/DQPSK encoder 28 and a second demultiplexer 34 for data rates of 5.5 Mbps and 11 Mbps. For the latter data rates the second demultiplexer 34 divides the received data stream into groups of four or eight consecutive bits, respectively and outputs each group of bits in parallel. Two of those bits are provided to the DBPSK/DQPSK encoder 28 whereas the remaining two (5.5 Mbps) or six bits (11 Mbps) are provided to look-up tables 36 and 37. The look-up tables 36 and 37 specify sequences of eight complex symbols. In order to illustrate this FIG. 2 shows look-up table 36 comprising the real parts of the symbols and look-up table 37 comprising the imaginary parts of the symbols. In total each look-up table comprises 64 (=2⁶) sequences. The complex symbols are provided sequentially by an interface to a multiplier 35 which also receives an output from the DBPSK/DQPSK encoder 28 which encodes the two bits received from second demultiplexer 34 via demultiplexer 30. The demultiplexer 30 thereby provides a second symbol. Each of the sequence of eight complex symbols provided by look-up tables 36 and 37 is multiplied by the corresponding second symbol provided by demultiplexer 30.

In the 1 and 2 Mbps modes the demultiplexer 26 forwards the data received from the scrambler 25 to the DBPSK/DQPSK encoder 28. For the 1 Mbps pay load data rate mode and for the header in all rates the encoder 28 implements a DBPSK coding by differentially encoding the received data and driving both the in-phase and quadrature channels I and Q, respectively, together. For the 2 Mbps data rate the encoder 28 implements a DQPSK data encoding of dibits (2 bits).

For data rates of 1 Mbps and 2 Mbps the demultiplexer 30 provides the data output by encoder 28 to real multipliers 31 and 32. Register 38 provides an 11 bit Barker word. The complex and real bit of each symbol output by demultiplexer 30 is multiplied by each of the 11 bits of Barker word stored in register 38. Multiplexer 33 which is controlled by control circuit 27 forwards either the output of real multipliers 31 and 32 or complex multiplier 35 to two digital pulse shaping filters 42 and 43 shown in FIG. 3 via lines 11 and 12, each for one of the in-phase component Ml or quadrature component MQ of the output of multiplexer 33. The output of the pulse shaping filters 42 and 43 is converted to the analog in-phase component TXI by digital-to-analog converter (DAC) 44 and the analog quadrature component TXQ is generated by DAC 45, respectively. The analog in-phase component TXI and the analog quadrature component are provided at outputs 17 and 18 to IF QMODEM e.g. a HFA 3783 may be connected to.

The scrambler 25 implements the scrambling algorithms specified in the IEEE 802.11 standard. The scrambler is used for the preamble, header and pay load data in all modes i.e. 1, 2, 5.5 and 11 Mbps. The scrambler comprises a 7-tab shift register. The output of the fourth and the seventh tab are XORed. The result of the XORed operation is XOR with the input serial data in order to generate the output serial data. The output serial data are input into the first tab of the shift register. The data are serially inputted into the scrambler 25 and serially outputted from the scrambler to the demultiplexer 26.

As mentioned above in the 1 Mbps mode the I and Q outputs of encoder 28 are connected together. Consequently the same bits are multiplied in the I and Q channel by the 11-bit Barker word provided from register 38. The encoder provides the data at rates of 1 Mbps on the I and Q output. The 11 bits of the Barker words are read out with a frequency of 11 MHz. This results in a higher chip rate at the outputs of multipliers 31 and 32 compared to the outputs of encoder 28 thereby generating a spread signal.

For the 2 Mbps mode the encoder 28 implements a DQPSK encoding resulting from the differential coding of dibits. For the 2 Mbps mode the serial data is formed into di bits or bit pairs in the differential encoder. One bit of the dibits outputs from the encoder 28 goes to the I output and the other to the Q output. The data provided at the I and Q outputs are both multiplied with the 11 bit Barker word at the spread rate of 11 MHz.

As explained above the signals output by multiplexer 33 via lines 11 and 12 are input into pulse shaping filters 42 and 43. In addition the pulse shaping filters are provided by a clock of 44 MHz from an oscillator 41. For each chip output via lines 11 and 12 each pulse shaping filter 42 and 43 calculates four 10-bit quasi analog values which are output to the digital-to-analog converters 44 and 45, respectively. By calculating four quasi analog values each having a resolution of 10 bit spectral components in the frequency range between 11 MHz and 44 MHz can be cancelled. Spectral components above 44 MHz have a low amplitude on one hand and are far away from the baseband frequency range of 0 to 11 MHz so that the latter components can not do any harm in the intermediate frequency stage (e.g. HFA 3783) or the radio frequency stage (e.g. HFA 3683 A).

It is noted that the IEEE 802.11b standard has relaxed spectral requirements.

In order to effectively cancel the signal components between 11 MHz and 44 MHz extensive calculations are necessary. As a consequence the pulse shaping filters 42 and 43 are the most complex part in the digital transmission baseband unit of the HFA 3861A. This means that the pulse shaping filters 42 and 43 require a big area on the silicon chips on which the baseband unit HFA 3861A is implemented.

Moreover a digital-to-analog converter for conversion rates of 44 MHz and 10 bit resolution requires complex circuitry and a considerable surface area on the chip.

It is desirable to provide a solution which requires less surface on the silicon chips.

### SUMMARY OF THE INVENTION

According to one embodiment a direct sequence spread spectrum encoder for digital information in wireless LANs is provided. The encoder comprises a register for storing an 11-bit Barker word and a multiplier connected to said register for serially receiving and multiplying the bits stored in the register by data bits for generating a spread signal. The encoder further comprising a digital-to-analog converter which is connected to an output of the multiplier for generating an analog signal based on the spread signal and a low pass filter connected to said digital-to-analog converter for low-pass filtering said analog signal in order to generate a low-pass filtered signal. The low-pass filter is connectable to a QMODEM.

According to another embodiment a direct sequence spread spectrum encoder for digital information in wireless LANs is provided. The encoder comprises a memory for storing a look-up table for mapping two inputted data bits to a selected sequence out of four selectable, nearly orthogonal sequences being selected from 2¹⁶ possible sequences. Each sequence is comprised of eight symbols. The encoder further comprises a memory interface connected to the memory to read out one symbol after another symbol of said selected sequence from said look up table. Finally the encoder comprises a digital-to-analog converter connected to an output of said memory interface for generating an analog signal based on the symbols outputted by said memory interface and a low-pass filter which is connected to the digital-to-analog converter for low-pass filtering the analog signaling in order to generate a low-pass filtered signal. The low-pass filter can be connected to a QMODEM.

According to a further embodiment a direct sequence spread spectrum encoder for digital information in wireless LANs is provided which comprises a spreading means for mapping two input data bits to one sequence out of four selectable, nearly orthogonal sequences being selected from 2¹⁶ possible sequences; each sequence comprises eight symbols. The spreading means serially outputs one symbol after another. The encoder further comprises a digital-to-analog converter connected to an output of said spreading means for generating an analog signal based on the symbols outputted by the spreading means and a low-pass filter which is connected to the digital-to-analog converter for low-pass filtering the analog signal in order to generate a low-pass filtered signal. The low-pass filter can be connected to a QMODEM.

According to yet another embodiment a direct sequence spread spectrum encoding method is provided which comprises generating a spread signal by multiplying a 11-bit Barker word by data bits. Each data bit is multiplied by each bit of the Barker word. The method further comprises digital-to-analog converting the spread signal in order to generate an analog signal and low-pass filtering the analog signal by an analog low-pass filter.

According to yet a further embodiment a direct sequence spread spectrum encoding method is provided. The method comprises mapping two inputted data bits to a selected sequence out of four selectable, nearly orthogonal sequences being selected from 2¹⁶ possible sequences to generate a spread signal. Each sequence comprises eight symbols. The method further comprises digital-to-analog converting the spread signal in order to generate an analog signal and low-pass filtering the analog signal by an analog low-pass filter.

### BRIEF DESCRIPTION OF THE DRAWINGS

Further embodiments, advantages and objects of the present invention are defined in the appended claims and will become apparent in the following detailed description when taken with reference to the accompanying drawings in which:

FIG. 1 shows an inventive pulse-shaping and digital-to-analog conversion stage;

FIG. 2 shows a circuit diagram of part of the transmitting section of an HFA 3861A;

FIG. 3 shows a pulse-shaping and digital-to-analog conversion stage of the HFA 3861A; and

FIG. 4 shows a Butterworth filter.

### DETAILED DESCRIPTION OF THE INVENTION

While the present invention is described with reference to the embodiments as illustrated in the following detailed description as well as in the drawings, it should be understood that the following detailed description as well as the drawings are not intended to limit the present invention to the particular illustrative embodiments disclosed, but rather the described illustrative embodiments merely exemplify the various aspects of the present invention, the scope of which is defined by the appended claims.

As previously explained due to the relaxed spectral requirements of the IEEE 802.11b standard the embodiments comprise a less complex pulse-filtering and digital-to-analog conversion stage which comprises a digital-to-analog converter for outputting an analog signal and a low-pass filter which removes high frequency components outside the baseband from the analog signal.

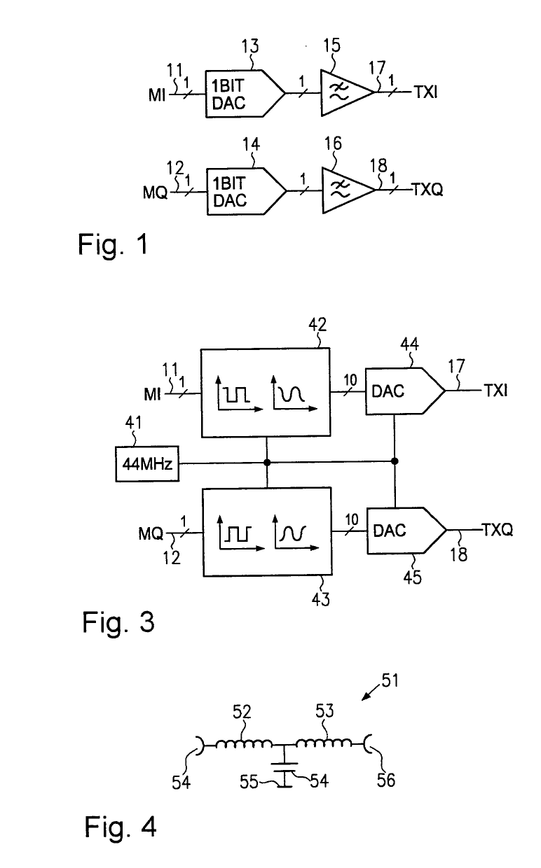

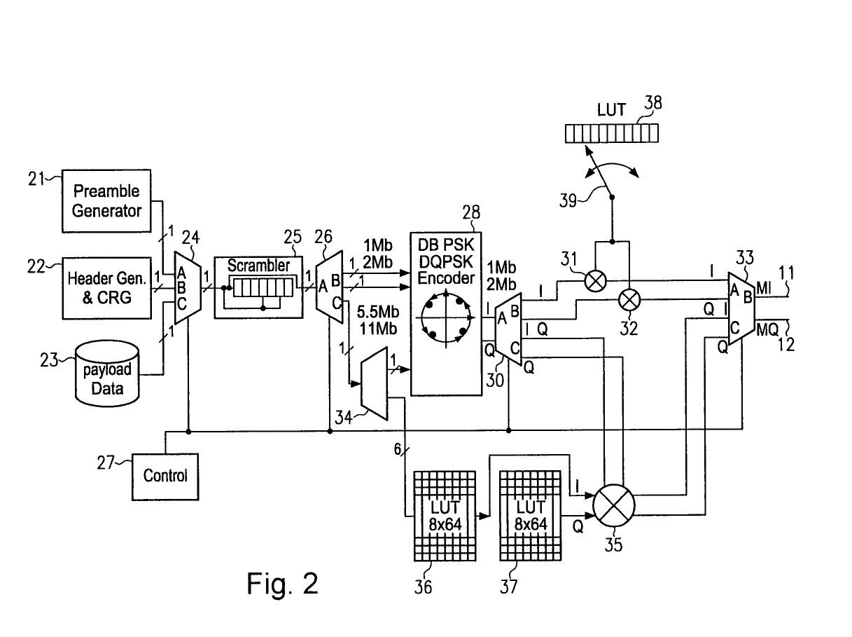

FIG. 1 shows a pulse-shaping and digital-to-analog conversion stage according to one embodiment. The output of mulitplexer 33 provided on lines 11 and 12 is input into two 1-bit digital-to-analog converters 13 and 14, respectively. In the embodiment lines 11 and 12 actually comprise only one line on which the chips are provided serially at a frequency of 11 MHz. Each of the 1-bit digital-to-analog converters 13 and 14 outputs an analog signal on a single line. Each of the analog signals is low-pass filtered by an analog low-pass filter 15 and 16. The outputs of the analog filters 15 and 16 are connectable to a QMODEM via lines 17 and 18, respectively. The in-phase component of the output signal is designated TXI and provided on line 17. The quadrature component is designated TXQ and provided on line 18.

The 1-bit digital-to-analog converters 13 and 14 are easy to implement and require only a small surface area on the chip. As a consequence the baseband encoders of this invention can be implemented on smaller chips. So a larger number of baseband encoders can be processed on a waver and production costs can be saved.

The low-pass filters 44 and 45 may be implemented by third-order Butterworth filters. Such a Butterworth filter 51 is shown in FIG. 4. The input voltage for the Butterworth filter is provided between ground 55 and input 54. The output voltage of the third order Butterworth filter is provided between output 56 and ground 55. The third order Butterworth filter comprises inductances 52 and 53 and capacitance 54. The input is connected to one terminal of inductance 52. The second terminal of inductance 52 is connected to a first terminal of inductance 53 and a first plate of capacitor 54. The other plate of capacitor 54 is connected to ground 55. The second terminal of inductance 53 provides the output of Butterworth filter 51.

Since it is desirable to integrate low pass filters 44 and 45 onto a silicon chip instead of Butterworth filter 51 a third order active RC filter may be used. Such filters comprise only resistors, capacitors and amplifiers but no inductances. Active RC filters up to the sixth order are well known in the art.

Analog low-pass filters are standard components and relatively simple. As a consequence analog filters help to reduce the overall costs of IEEE 802.11 WLAN transmitters.

Further modifications and variations of the present invention will be apparent to those skilled in the art in view of this description. Accordingly this description is to be construed as illustrative only and is for the purpose of teaching those skilled in the art the general manner of carrying out the present invention.

1. A direct sequence spread spectrum encoder for digital information in wireless LANs comprising:
a register (38) storing an 11-bit Barker word;
a multiplier (31, 32) connected to said register (38) for serially receiving and multiplying the bits stored in said register (38) by data bits (21, 22, 23) for generating a spread signal;
a digital-to-analog converter (13, 14) connected to an output of said multiplier (31, 32) for generating an analog signal based on said spread signal; and
a low-pass filter (15, 16) connected to an output of said digital-to-analog converter (13, 14) for low-pass filtering said analog signal in order to generate a low-pass filtered signal; said low-pass filter being connectable to a QMODEM.

2. The encoder of claim 1, further comprising a DBPSK-encoder (28) an output of said DBPSK-encoder (28) being connected to an input of said multiplier (31, 32); said DBPSK-encoder (28) receiving data bits (21, 22, 23) and providing differentially encoded bits to said multiplier (31, 32).

3. The encoder of claim 1, further comprising a DQPSK-encoder (28) an output of said DQPSK-encoder (28) being connected to an input of said multiplier (31, 32); said DQPSK-encoder (28) receiving data bits (21, 22, 23) and providing differentially encoded bits to said multiplier (31, 32).

4. The encoder of claim 1, further comprising a scrambler (25) comprising a 7-tab shift register; an output of said scrambler (25) being connected to said multiplier (31, 32) for providing scrambled data bits to said multiplier (31, 32).

5. The encoder of claim 1, wherein said digital-to-analog converter (13, 14) is a one-bit digital-to-analog converter.

6. The encoder of claim 1, wherein said low-pass filter (15, 13) being a third-order Butterworth filter (51).

7. A direct sequence spread spectrum encoder for digital information in wireless LANs comprising:
a memory for storing a look-up table (36, 37) for mapping two inputted data bits (23) to a selected sequence out of 4 selectable, nearly orthogonal sequences being selected from 2¹⁶ possible sequences; each sequence being comprised of eight symbols;
a memory interface connected to said memory to read out one symbol after another symbol of said selected sequence from said look-up table (36, 37);
a digital-to-analog converter (13, 14) connected to an output of said memory interface for generating an analog signal based on said symbols outputted by said memory interface; and
a low-pass filter (15, 16) connected to an output of said digital-to-analog converter (13, 14) for low-pass filtering said analog signal in order to generate a low-pass filtered signal; said low-pass filter being connectable to a QMODEM.

8. The encoder of claim 7, said look-up table (36, 37) mapping six inputted data bits to one sequence of sixty-four selectable, nearly orthogonal sequences being selected from said 2¹⁶ possible sequences.

9. The encoder of claim 7, wherein each of the eight symbols forming a selectable sequence is a complex symbol;
said encoder further comprising a complex multiplier (35); a first input of said complex multiplier (35) being connected to an output of said memory interface and a second input of said complex multiplier (35) receiving a second symbol; said complex multiplier (35) multiplying a said selected sequence of symbols serially by said second symbol.

10. The encoder of claim 9, said encoder further comprising a DQPSK encoder (28) for encoding two additional data bits by differential quadrature phase shift keying in order to generate said second symbol, an output of said DQPSK encoder being connected to said second input of said complex multiplier (35) for providing said second symbol to said complex multiplier (35).

11. The encoder of claim 9, said encoder further comprising a DQPSK encoder (28), a demultiplexer (30), a multiplexer (33) and a control circuit (27); an input of said demultiplexer (30) being connected to an output of said DQPSK encoder (28), a first output of said demultiplexer (30) being connected to a first input of said multiplexer (33); a second output of said demultiplexer (30) being connected to a second input of said complex multiplier (35); said output of said complex multiplier (35) being connected to a second input of said multiplexer (33); an output of said multiplexer (33) being connected to said digital-to-analog converter (13, 14); said control circuit being connected to said demultiplexer (30) and said multiplexer (33) for selecting data bits provided by said DQPSK encoder (28) or said multiplier (35).

12. The encoder of claim 11, wherein said control circuit (27) selects data bits provided by DQPSK encoder (28) if the data bits belong to a preamble (21) or a header (22) and said control circuit selects data bits provided by said multiplier (35) if the data bits constitute pay-load data (23).

13. The encoder of claim 7, said encoder further comprising a scrambler (25) having a 7-tab shift register for scrambling the input data bits.

14. The encoder of claim 7, wherein said digital-to-analog converter (13, 14) is a one bit digital-to-analog converter.

15. The encoder of claim 7, wherein said low-pass filter (15, 16) is a third-order Butterworth filter (51).

16. A direct sequence spread spectrum encoder for digital information in wireless LANs comprising:
a spreading means (36, 37) for mapping two input data bits to one sequence out of four selectable, nearly orthogonal sequences being selected from 2¹⁶ possible sequences; each sequence being comprised of eight symbols; said spreading means (36, 37) serially outputting one symbol after another;
a digital-to-analog converter (13, 14) connected to an output of said spreading means for generating an analog signal based on said symbols outputted by said spreading means (36, 37); and
a low-pass filter (15, 16) connected to an output of said digital-to-analog converter (13, 14) for low-pass filtering said analog signal in order to generate a low-pass filtered signal; said low-pass filter being connectable to a QMODEM.

17. The encoder of claim 16, said spreading means (36, 37) for mapping six input data bits to one sequence out of sixty-four selectable nearly orthogonal sequences being selected from said 2¹⁶ possible sequences.

18. The encoder of claim 16, said digital-to-analog converter being a one bit digital-to-analog converter.

19. A direct sequence spread spectrum encoding method comprising:
generating a spread signal by multiplying (31, 32) an 11-bit Barker word (38) by data bits (21, 22, 23); each data bit being multiplied by each bit of said Barker word;
digital-to-analog converting (13, 14) said spread signal in order to generate an analog signal; and
low-pass filtering said analog signal by an analog low-pass filter (15, 16).

20. The method of claim 19, further comprising DBPSK encoding (28) said data bits (21, 22, 23) before multiplying (31, 32) them by said Barker word.

21. The method of claim 19, further comprising DQPSK encoding (28) said data bits (21, 22, 23) before multiplying said data bits (21, 22, 23) by said Barker word (38).

22. The method of claim 19, further comprising scrambling (25) said data bits (21, 22, 23) before multiplying said data bits (21, 22, 23) by said Barker word (38).

23. The method of claim 19, wherein said digital-to-analog converting is performed by a 1-bit digital-to-analog converter (13, 14).

24. A direct sequence spread spectrum encoding method comprising:
mapping (36, 37) two inputted data bits to a selected sequence out of four selectable, nearly orthogonal sequences being selected from 2¹⁶ possible sequences to generate a spread signal; each sequence being comprised of eight symbols;
digital-to-analog converting (13, 14) said spread signal in order to generate an analog signal; and
low-pass filtering said analog signal by an analog low-pass filter (15, 16).

25. The method of claim 24, wherein said mapping maps six inputted data bits to one sequence out of 64 selectable, nearly orthogonal sequences being selected from 2¹⁶ possible sequences.

26. The method of claim 24, wherein each of the eight symbols forming a sequence are complex symbols; said method further comprising multiplying said selected sequence of symbols serially by a second symbol in order to generate a multiplied sequence.

27. The method of claim 26, further comprising DQPSK encoding (28) 2 additional data bits in order to generate said second symbol.

28. The method of claim 27, further comprising selecting either said second symbol or said multiplied sequence for digital-to-analog conversion; said second symbol being selected if it belongs to a preamble (21) or a header (22) and said multiplied sequence being selected if said data bits constitute pay-load data.

29. The method of claim 28 further comprising scrambling (25) said input data bits by a 7-tab shift register.

30. The method of claim 24, wherein said digital-to-analog converting is performed by a one bit digital-to-analog converter (13, 14).

31. The method of claim 19, wherein said low-pass filtering is performed by a third-order Butterworth filter (51).
